(19) United States
(12) Patent Application Publication
(10) Pub. No.: US 2018/0122315 A1
(43) Pub. Date: May 3, 2018

(54) SHIFT REGISTER AND METHOD FOR DRIVING THE SAME, GATE DRIVING CIRCUIT, AND DISPLAY APPARATUS

(71) Applicants: BOE TECHNOLOGY GROUP CO., LTD., Beijing (CN); HEFEI BOE OPTOELECTRONICS TECHNOLOGY CO., LTD., Hefei (CN)

(72) Inventors: Xiaojie Zhang, Beijing (CN); Xianjie Shao, Beijing (CN); Junsheng Chen, Beijing (CN)

(21) Appl. No.: 15/682,522

(22) Filed: Aug. 21, 2017

(30) Foreign Application Priority Data
Oct. 28, 2016 (CN) 201610968626.0

(51) Int. Cl. G09G 3/36

(52) U.S. Cl. CPC G09G 3/3611; G09G 2310/08; G09G 2310/0286

(57) ABSTRACT

The embodiments of the present disclosure provide a shift register and a method for driving the same, a gate driving circuit, and a display apparatus. The shift register comprises input circuitry, storage circuitry, output circuitry, reset circuitry, pull-down circuitry, and pull-down control circuitry. The shift register and the method for driving the same, the gate driving circuit, and the display apparatus according to the embodiments of the present disclosure can reduce noise interference.

### CROSS-REFERENCE TO RELATED APPLICATION(S)

This application claims priority to the Chinese Patent Application No. 201610968626.0, filed on Oct. 28, 2016, entitled “SHIFT REGISTER UNIT AND METHOD FOR DRIVING THE SAME, GATE DRIVING CIRCUIT, AND DISPLAY APPARATUS,” which is incorporated herein by reference in its entirety.

### TECHNICAL FIELD

The present disclosure relates to the field of display technology, and more particularly, to a shift register and a method for driving the same, a gate driving circuit, and a display apparatus.

### BACKGROUND

In displays, drivers are used in driving pixel units for implementing display functions. By taking a liquid crystal display as an example, a driver comprises a gate driver and a data driver. The gate driver comprises a plurality of cascaded shift registers. When a shift register is in an output phase, a gate driving signal is generated according to an input signal and a clock signal and is applied to a gate line connected to pixel units. When the shift register is in other phases, an invalid signal (for example, a low level signal) is output.

During a long period of use, threshold voltages of transistors in a shift register may drift and interference may be generated between adjacent transistors. This may cause a noisy invalid signal output by the shift register, which may result in an abnormal display function.

There are possibilities for improvements in the shift register and the gate driving circuit.

### SUMMARY

In order to at least partially solve or alleviate the above problems, the embodiments of the present disclosure provide a shift register and a method for driving the same, a gate driving circuit, and a display apparatus.

According to a first aspect of the present disclosure, there is provided a shift register, comprising: input circuitry, storage circuitry, output circuitry, reset circuitry, pull-down circuitry and pull-down control circuitry. The input circuitry is coupled to an input signal terminal, a first voltage terminal and the storage circuitry and is configured to receive an input signal and output the received input signal to the storage circuitry. A pull-up point is between the input circuitry and the storage circuitry. The storage circuitry is coupled to the output circuitry and is configured to store the input signal. The output circuitry is coupled to the storage circuitry, a clock signal terminal and an output signal terminal and is configured to output a clock signal from the clock signal terminal to the output signal terminal. The reset circuitry is coupled to a reset signal terminal, a second voltage terminal and the pull-up point and is configured to reset the pull-up point according to a reset signal. The pull-down control circuitry is coupled to a third voltage terminal and the pull-down circuitry and is configured to control the pull-down circuitry. The pull-down circuitry is coupled to the output signal terminal, a fourth voltage terminal and the pull-up point and is configured to pull down levels at the output signal terminal and the pull-up point under the control of the pull-down control circuitry.

In embodiments of the present disclosure, the pull-down control circuitry comprises a first transistor and boost circuitry. A pull-down point is between the pull-down control circuitry and the pull-down circuitry. The first transistor has a control electrode coupled to the third voltage terminal, a first electrode coupled to the third voltage terminal and a second electrode coupled to the pull-down point. The boost circuitry is coupled between the control electrode and the second electrode of the first transistor and is configured to raise a voltage between the control electrode and the second electrode of the first transistor.

In embodiments of the present disclosure, the boost circuitry comprises a first capacitor coupled between the control electrode and the second electrode of the first transistor.

In embodiments of the present disclosure, the pull-down control circuitry further comprises a second transistor and a third transistor. The second transistor has a control electrode and a first electrode each coupled to the third voltage terminal and a second electrode coupled to the control electrode of the first transistor. The third transistor has a control electrode coupled to the pull-up point, a first electrode coupled to the second electrode of the first transistor and a second electrode coupled to the fourth voltage terminal.

In embodiments of the present disclosure, the input circuitry comprises a fourth transistor. The fourth transistor has a control electrode coupled to the input signal terminal, a first electrode coupled to the first voltage terminal and a second electrode coupled to the pull-up point.

In embodiments of the present disclosure, the output circuitry comprises a fifth transistor. The fifth transistor has a control electrode coupled to the pull-up point, a first electrode coupled to the clock signal terminal and a second electrode coupled to the output signal terminal.

In embodiments of the present disclosure, the storage circuitry comprises a second capacitor. The second capacitor has two terminals coupled to the output circuitry, respectively.

In embodiments of the present disclosure, the reset circuitry comprises a sixth transistor. The sixth transistor has a control electrode coupled to the reset signal terminal, a first electrode coupled to the pull-up point and a second electrode coupled to the second voltage terminal.

In embodiments of the present disclosure, the pull-down circuitry comprises a seventh transistor and an eighth transistor. A pull-down point is between the pull-down control circuitry and the pull-down circuitry. The seventh transistor has a control electrode coupled to the pull-down point, a first electrode coupled to the output signal terminal and a second electrode coupled to the fourth voltage terminal. The eighth transistor has a control electrode coupled to the pull-down point, a first electrode coupled to the pull-up point and a second electrode coupled to the fourth voltage terminal.

According to a second aspect of the present disclosure, there is provided a method for driving a shift register, which is used to drive the shift register described above. The method comprises the following phases. In a first phase, a valid input signal is received from an input signal terminal at input circuitry, a signal from a first voltage terminal is output by the input circuitry to a pull-up point, and the signal from the first voltage terminal is stored by storage circuitry. In a second phase, a valid clock signal provided by a clock signal terminal is output by the output circuitry to an output signal terminal under the control of a valid voltage output by the storage circuitry. In a third phase, a valid reset signal is received by a reset signal terminal at reset circuitry, a voltage at the pull-up point is reset by the reset circuitry to a voltage at a second voltage terminal under the control of the reset signal; and a valid signal from the third voltage terminal is output by pull-down control circuitry to a pull-down point, wherein a level at the output signal terminal is pulled down by the pull-down circuitry under the control of the valid signal at the pull-down point. In a fourth phase, the valid signal from the third voltage terminal is kept being output by the pull-down control circuitry to the pull-down point, and the level at the output signal terminal is kept being pulled down by the pull-down circuitry under the control of the valid signal at the pull-down point.

According to a third aspect of the present disclosure, there is provided a gate driving circuit comprising a plurality of cascaded shift registers described above, wherein an output signal terminal of a shift register at a previous stage is coupled to an input signal terminal of a shift register at a current stage, and an output signal terminal of a shift register at a next stage is coupled to a reset signal terminal of the shift register at the current stage.

According to a fourth aspect of the present disclosure, there is provided a display apparatus comprising the gate driving circuit described above.

### BRIEF DESCRIPTION OF THE DRAWINGS

In order to more clearly illustrate the technical solutions according to the embodiments of the present disclosure, the accompanying drawings of the embodiments will be briefly described below, and it should be understood that the accompanying drawings described below only relate to some embodiments of the present disclosure and are not intended to limit the present disclosure, wherein in accompanying drawings:

FIG. 1 is a block diagram of a shift register according to an embodiment of the present disclosure;

FIG. 2 is a block diagram of a gate driving circuit comprising the shift register shown in FIG. 1;

FIG. 3 is a circuit diagram of a shift register according to an embodiment of the present disclosure;

FIG. 4 is a flowchart of a method for driving a shift register according to an embodiment of the present disclosure; and

FIG. 5 is a signal timing diagram of the shift register shown in FIG. 3.

### DETAILED DESCRIPTION

In order to make the technical solutions and advantages of the embodiments of the present disclosure more obvious, the technical solutions according to the embodiments of the present disclosure will be described clearly and completely below with reference to the accompanying drawings. It is obvious that the described embodiments are a part of the embodiments of the present disclosure instead of all the embodiments. All other embodiments obtained by those skilled in the art based on the described embodiments of the present disclosure without contributing any creative work are also within the protection scope of the present disclosure.

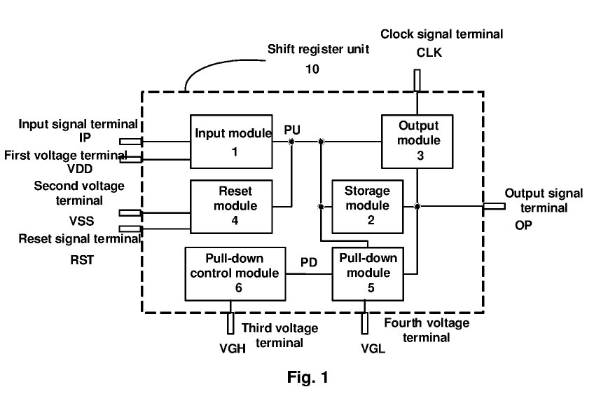

FIG. 1 is a block diagram of a shift register 10 according to an embodiment of the present disclosure. As shown in FIG. 1, the shift register 10 may comprise input circuitry 1, storage circuitry 2, output circuitry 3, reset circuitry 4, pull-down circuitry 5 and pull-down control circuitry 6. The input circuitry 1 is coupled to an input signal terminal IP, a first voltage terminal VDD and the storage circuitry 2, and is configured to receive an input signal and output the received input signal to the storage circuitry 2. A connection point between the input circuitry 1 and the storage circuitry 2 is a pull-up point PU. The storage circuitry 2 is coupled to the output circuitry 3, and is configured to store the input signal. The output circuitry 3 is coupled to the storage circuitry 2, a clock signal terminal CLK and an output signal terminal OP, and is configured to output a clock signal from the clock signal terminal CLK to the output signal terminal OP. The reset circuitry 4 is coupled to a reset signal terminal RST, a second voltage terminal VSS and the pull-up point PU, and is configured to reset the pull-up point PU according to a reset signal. The pull-down circuitry 5 is coupled to a fourth voltage terminal VGL and the output signal terminal OP, may also be coupled to the pull-up point PU, and is configured to pull down levels at the output signal terminal OP and the pull-up point PU under the control of the pull-down control circuitry 6. The pull-down control circuitry 6 is coupled to a third voltage terminal VGH and the pull-down circuitry 5, and is configured to control the pull-down circuitry 5. A connection point where the pull-down control circuitry 6 is coupled to the pull-down circuitry 5 is a pull-down point PD.

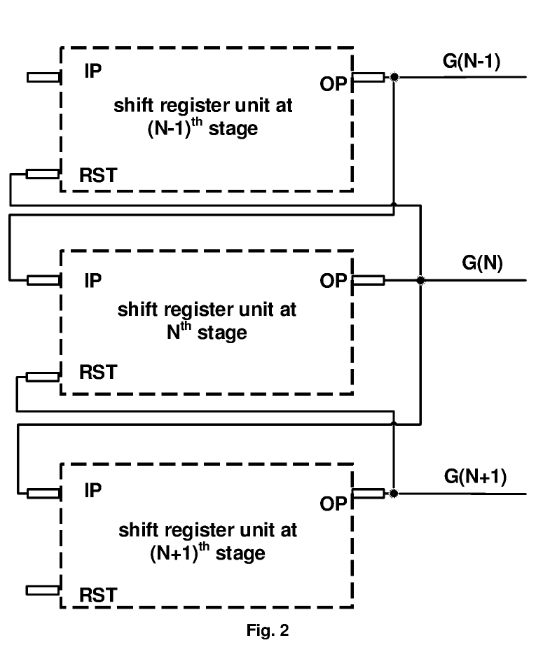

FIG. 2 is a block diagram of a gate driving circuit comprising the shift register shown in FIG. 1. As shown in FIG. 2, the shift registers in FIG. 1 may be cascaded to form a gate driving circuit. When the shift registers are cascaded, an output signal terminal OP (also indicated by G(N−1) in the figure) of a shift register at a previous stage coupled to an input signal terminal IP of a shift register at a current stage. An output signal terminal OP (also indicated by G(N+1) in the figure) of a shift register at a next stage is coupled to a reset signal terminal RST of the shift register at the current stage. In the present embodiment, connection relationships among various stages may be deduced by analogy.

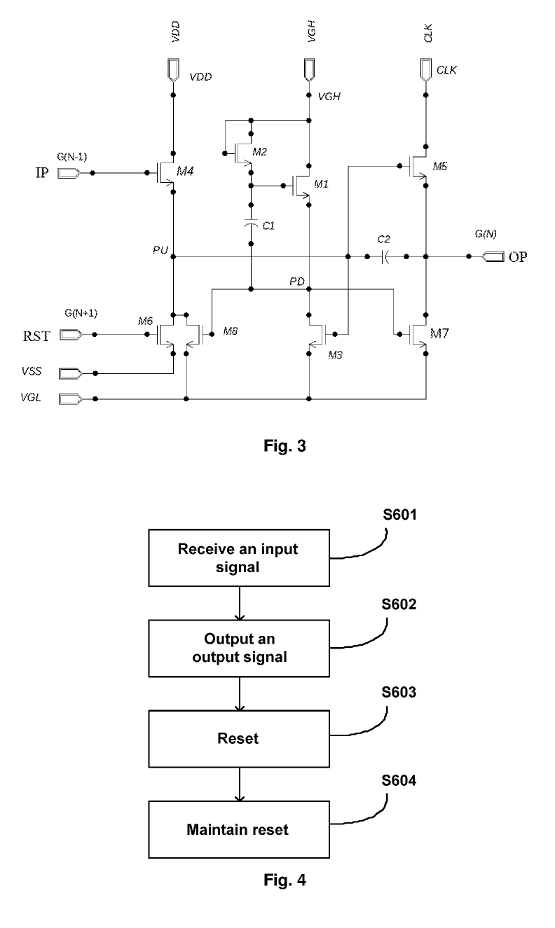

FIG. 3 is a circuit diagram of a shift register according to an embodiment of the present disclosure.

As shown in FIG. 3, the pull-down control circuitry 6 comprises a first transistor M1 and boost circuitry. The first transistor M1 has a control electrode coupled to the third voltage terminal VGH, a first electrode coupled to the third voltage terminal VGH and a second electrode coupled to the pull-down point PD. The boost circuitry is coupled between the control electrode and the second electrode of the first transistor M1, and is configured to raise a voltage between the control electrode and the second electrode of the first transistor M1. Specifically, the boost circuitry comprises a first capacitor C1 coupled between the control electrode and the second electrode of the first transistor M1. With bootstrap effects of the first capacitor C1, the voltage can be raised rapidly.

The pull-down control circuitry 6 may further comprise a second transistor M2 and a third transistor M3. The control electrode of the first transistor M1 is coupled to the third voltage terminal VGH via the second transistor M2. Specifically, the control electrode of the first transistor M1 is coupled to a second electrode of the second transistor M2, and a control electrode and a first electrode of the second transistor M2 are coupled to the third voltage terminal VGH. The third transistor has a control electrode coupled to the pull-up point PU, a first electrode coupled to the pull-down point PD (i.e., the second electrode of the first transistor M1), and a second electrode coupled to the fourth voltage terminal VGL. The third transistor M3 can enable control of the voltage at the pull-down point PD by the voltage at the pull-up point PU, and when the voltage at the pull-up point PU causes the third transistor M3 to be turned on, the pull-down point PD is coupled to the fourth voltage terminal VGL.

Further, as shown in FIG. 3, the input circuitry 1 comprises a fourth transistor M4. The storage circuitry 2 comprises a second capacitor C2. The output circuitry 3 comprises a fifth transistor M5. The reset circuitry 4 comprises a sixth transistor M6. The pull-down circuitry 5 comprises a seventh transistor M7 and an eighth transistor M8.

The fourth transistor M4 has a control electrode coupled to the input signal terminal IP, a first electrode coupled to the first voltage terminal VDD and a second electrode coupled to the pull-up point PU. The fifth transistor M5 has a control electrode coupled to the pull-up point PU, a first electrode coupled to the clock signal terminal CLK and a second electrode coupled to the output signal terminal OP. The second capacitor C2 is coupled between the control electrode and the second electrode of the fifth transistor M5. The sixth transistor M6 has a control electrode coupled to the reset signal terminal RST, a first electrode coupled to the pull-up point PU and a second electrode coupled to the second voltage terminal VSS. The seventh transistor M7 has a control electrode coupled to the pull-down point PD, a first electrode coupled to the output signal terminal OP and a second electrode coupled to the fourth voltage terminal VGL. The eighth transistor M8 has a control electrode coupled to the pull-down point PD, a first electrode coupled to the pull-up point PU and a second electrode coupled to the fourth voltage terminal VGL.

FIG. 4 is a flowchart of a method for driving a shift register according to an embodiment of the present disclosure. The driving method starts at step S601 where an input signal is received, i.e., a first phase T1. Then, the process proceeds to step S602 where an output signal is output, i.e., a second phase T2. Subsequently, the process proceeds to step S603 where reset is performed, i.e., a third phase T3. Finally, the process proceeds to step S604 where reset is maintained, i.e., a fourth phase T4.

In the first phase T1, a valid input signal is provided by the input signal terminal IP to the input circuitry 1, a signal from the first voltage terminal VDD is output by the input circuitry 1 to the pull-up point PU, and the signal from the first voltage terminal VDD is stored by the storage circuitry 2. In the second phase T2, a valid voltage is output by the storage circuitry 2 to the output circuitry 3, and a valid clock signal provided by a clock signal terminal CLK is output by the output circuitry 3 to the output signal terminal OP under the control of the valid voltage output by the storage circuitry 2. In the third phase T3, a valid reset signal is provided by the reset signal terminal RST to the reset circuitry 4, a voltage at the pull-up point PU is reset by the reset circuitry 4 to a voltage at the second voltage terminal VSS under the control of the reset signal; a valid signal is provided by the third voltage terminal VGH to the pull-down control circuitry 6, and the valid signal from the third voltage terminal VGH is output by the pull-down control circuitry 6 to the pull-down point PD, wherein the boost circuitry of the pull-down control circuitry 6 increases a speed at which the valid signal from the third voltage terminal VGH is output to the pull-down point PD; and a level at the output signal terminal OP is pulled down by the pull-down circuitry 5 under the control of the valid signal at the pull-down point PD. In the fourth phase T4, the valid signal is kept being provided by the third voltage terminal VGH, the valid signal from the third voltage terminal VGH is kept being output by the pull-down control circuitry 6 to the pull-down point PD, and the level at the output signal terminal OP is kept being pulled down by the pull-down circuitry 5 under the control of the valid signal at the pull-down point PD.

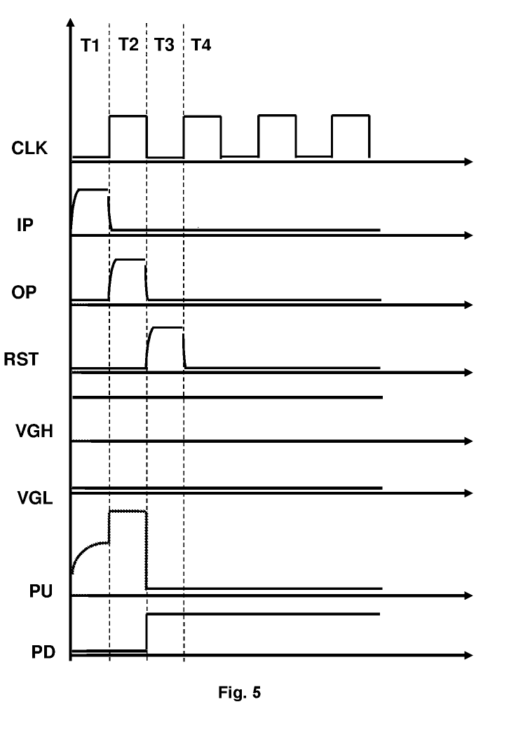

Hereinafter, various phases will be described in detail with reference to FIG. 5.

FIG. 5 is a signal timing diagram of the shift register shown in FIG. 3. As shown in FIG. 5, the third voltage terminal VGH may always be at a high level, and the fourth voltage terminal VGL may always be at a low level. In addition, the first voltage terminal VDD and the second voltage terminal VSS may be at opposite levels (for example, a high level and a low level) respectively. The present disclosure will be described below by taking the first voltage terminal VDD always being at a high level and the second voltage terminal VSS always being at a low level as an example. In this case, the driving process is forward scanning.

In the first phase T1, a valid input signal is input to the input signal terminal IP, an invalid reset signal is provided to the reset signal terminal RST, an invalid clock signal is provided to the clock signal terminal CLK, the pull-up point PU is at a valid level, the pull-down point PD is at an invalid level, and an invalid output signal is output by the output circuitry 3.

Specifically, in the first phase T1, an output signal from an output signal terminal G(n−1) of a shift register at a previous stage, which is used as the input signal, is at a high level, and the input signal at a high level causes the fourth transistor M4 of the input circuitry 1 to be turned on to couple the first voltage terminal VDD and the second capacitor C2 of the storage circuitry 2. The voltage at the first voltage terminal VDD is at a high level, and the high level voltage is transmitted to the second capacitor C2 to charge the second capacitor C2. This causes the voltage at the pull-up point PU to be raised to a high level, and causes the fifth transistor M5 of the output circuitry 3 to be turned on to couple the clock signal terminal CLK to the output signal terminal OP. The low level voltage at the clock signal terminal CLK is transmitted to the output signal terminal OP, and a low level signal is output by the output signal terminal OP.

In the pull-down control circuitry 6, as the voltage at the pull-up point PU is at a high level, the third transistor M3 is turned on. The pull-down point PD is coupled to the fourth voltage terminal VGL. Thus, the low level voltage at the fourth voltage terminal VGL is transmitted to the pull-down point PD so that the voltage at the pull-down point PD is at a low level.

In the pull-down circuitry 5, as the voltage at the pull-down point PD is at a low level, the seventh transistor M7 and the eighth transistor M8 are turned off, which ensures that the PU point is maintained at a high level in this phase.

In the reset circuitry 4, as an output signal from an output signal terminal G(n+1) of a shift register at a next stage, which is used as the reset signal, is at a low level, the sixth transistor M6 is turned off and reset is not performed in the shift register unit.

In the second phase T2, an invalid input signal is provided to the input signal terminal IP, an invalid reset signal is provided to the reset signal terminal RST, a valid clock signal is provided to the clock signal terminal CLK, the pull-up point PU is at a valid level, the pull-down point PD is at an invalid level, and a valid output signal is output by the output circuitry 3.

Specifically, in the second phase T2, the invalid signal from the input signal terminal IP causes the fourth transistor M4 to be turned off to disconnect the first voltage terminal VDD from the second capacitor C2 of the storage circuitry 2. A voltage across the second capacitor C2 is maintained to be constant, which causes the voltage at the pull-up point PU to be kept at a high level and causes the fifth transistor M5 of the output circuitry 3 to continue to be turned on so as to couple the clock signal terminal CLK and the output signal terminal OP. The high level voltage at the clock signal terminal CLK is transmitted to the output signal terminal OP, and a high level signal is output by the output signal terminal OP. Also, as the voltage difference across the second capacitor C2 is maintained to be stable, the voltage at the pull-up point PU is further raised, which ensures that the fifth transistor M5 is turned on stably, thereby ensuring that the output signal is stably kept at a high level.

In the pull-down control circuitry 6, as the voltage at the pull-up point PU is kept at a high level, the third transistor M3 is maintained to be turned on and the voltage at the pull-down point PD is maintained at a low level.

The states of the pull-down circuitry 5 and the reset circuitry 4 do not change.

In the third phase T3, an invalid input signal is provided to the input signal terminal IP, a valid reset signal is provided to the reset signal terminal RST, an invalid clock signal is provided to the clock signal terminal CLK, the pull-up point PU is at an invalid level, the pull-down point PD is at a valid level, and an invalid output signal is output by the output circuitry 3.

Specifically, in the third phase T3, the output signal from the output signal terminal G(n+1) of the shift register at the next stage, which is used as the reset signal, is at a high level, and the high level signal causes the sixth transistor M6 in the reset circuitry 4 to be turned on to couple the pull-up point PU and the second voltage terminal VSS. Therefore, a low level voltage at the second voltage terminal VSS is transmitted to the pull-up point PU, and the voltage at the pull-up point PU becomes a low level.

In the pull-down control circuitry 6, the voltage at the pull-up point PU is at a low level, so that the third transistor M3 is turned off. Further, the voltage at the third voltage terminal VGH is at a high level, so that the second transistor M2 is turned on to couple the control electrode of the first transistor M1 and the third voltage terminal VGH. The high level voltage at the third voltage terminal VGH causes the first transistor M1 to be turned on to couple the pull-down point PD and the third voltage terminal VGH. The high level voltage at the third voltage terminal VGH is transmitted to the pull-down point PD.

In this process, as a voltage difference across the first capacitor C1 is maintained to be stable, the voltage of the control electrode of the first transistor M1 is further raised, and the first capacitor C1 realizes a boost function. This increases the speed at which the first transistor M1 is turned on, which can increase the speed at which the high level voltage at the third voltage terminal VGH is output to the pull-down point PD, and can ensure that the first transistor M1 is turned on stably, thereby ensuring that the level at the pull-down point PD is stably kept at a high level.

In the pull-down circuitry 5, as the voltage at the pull-down point PD is at a high level, the seventh transistor M7 and the eighth transistor M8 are turned on to couple the output signal terminal OP and the pull-up point PU to the fourth voltage terminal VGL, respectively. The low level voltage at the fourth voltage terminal VGL is transmitted to the pull-up point PU and the output signal terminal OP. As a speed at which the voltage at the pull-down point PD is raised is increased, a speed at which the seventh transistor M7 and the eighth transistor M8 are turned on is also increased, and the seventh transistor M7 and the eighth transistor M8 can quickly and stably pull down the voltages at the pull-up point PU and the output signal terminal OP, which is advantageous for noise suppression.

In the fourth phase T4, an invalid input signal is provided to the input signal terminal IP, an invalid reset signal is provided to the reset signal terminal RST, the pull-up point PU is at an invalid level, the pull-down point PD is at a valid level, and an invalid output signal is output by the output circuitry 3.

Specifically, in the fourth phase T4, the invalid input signal from the input signal terminal IP causes the fourth transistor M4 of the input circuitry 1 to be turned off, and the invalid reset signal from the reset signal terminal RST causes the sixth transistor M6 of the reset circuitry 4 to be turned off.

The voltage at the third voltage terminal VGH continues to be at a high level, so that the second transistor M2 is turned on to couple the control electrode of the first transistor M1 and the third voltage terminal VGH. The high level voltage at the third voltage terminal VGH causes the first transistor M1 to be turned on to couple the pull-down point PD and the third voltage terminal VGH. The high level voltage at the third voltage terminal VGH is kept being transmitted to the pull-down point PD.

As the voltage at the pull-down point PD is at a high level, the seventh transistor M7 and the eighth transistor M8 are turned on, and the low level voltage at the fourth voltage terminal VGL is kept being transmitted to the pull-up point PU and the output signal terminal OP. This state will be kept to a next first phase T1. Also, the voltage of the control electrode of the first transistor M1 is always maintained at the raised level, and the high level voltage at the pull-down point PD is more stable so that the voltage at the output signal terminal OP can be stably maintained at a low level.

The shift register and the gate driving circuit described above can be used for driving a pixel unit of a display apparatus. It is to be understood that if the first voltage terminal VDD is always at a low level and the second voltage terminal VSS is always at a high level, the shift register can still operate in the same way by using the sixth transistor M6 as the input circuitry 1 and the first transistor M1 as the reset circuitry 4, and at this time, the driving process is reverse scanning.

In addition, for a display apparatus which requires only forward scanning, the input signal terminal IP may be coupled to the first voltage terminal VDD to simplify the circuit.

The shift register and the method for driving the same according to the embodiments of the present disclosure can reduce noise interference. The shift register enables rapid de-noising when there is no output and reduces a falling time of an output waveform.

In addition, the second transistor M2 may be omitted in the pull-down control circuitry 6, and the pull-down control circuitry 6 is directly coupled to the control electrode and the first electrode of the first transistor M1.

Further, the function of the third transistor M3 is such that the level at the pull-down point PD is low in the first phase T1 and the second phase T2 to ensure a normal output function. The third transistor M3 may be replaced with another circuit having the same functions. For example, the third transistor M3 may be omitted, and the pull-down point PD is directly coupled to a signal source which outputs a low level to the pull-down point PD in the first phase T1 and the second phase T2, and is turned off in the third phase T3 and the fourth phase T4.

These improvements can achieve the same functions.

The embodiments of the present disclosure further provide a gate driving circuit comprising cascaded shift register, which can improve the output characteristics of the gate driving circuit.

The embodiments of the present disclosure further provide a display apparatus comprising the gate driving circuit described above. The display apparatus may be any product or component having a display function such as a mobile phone, a tablet computer, a television set, a display, a notebook computer, a digital photo frame, a navigator, etc.

The shift register and the method for driving the same, the gate driving circuit, and the display apparatus according to the embodiments of the present disclosure can reduce noise interference.

In the foregoing description, as is generally understood in the art, “valid” means that when a corresponding signal or voltage is applied to corresponding circuitry, the circuitry performs a function (for example, a switch transistor in the circuitry is turned on); and “invalid” means that when a corresponding signal or voltage is applied to a corresponding circuitry, the circuitry does not perform a function (for example, a switch transistor in the circuitry is turned off).

In addition, the present disclosure is described by taking the transistor being an N-type transistor as an example, and accordingly, the valid level is a high level and the invalid level is a low level. It should be noted that the high level and the low level are only used to distinguish whether the voltage can turn on the transistor instead of limiting values of the voltages. For example, the low level may refer to a ground level or a negative level. In addition, the N-type TFT transistor is selected for illustration, instead of limiting a specific type of the transistor. According to the principles of the present disclosure, those skilled in the art can make appropriate selections and adjustments of the type of transistor without contributing any creative work, and these selections and adjustments are also considered to be within the protection scope of the present disclosure.

It is to be understood that the above embodiments are merely illustrative embodiments for the purpose of illustrating the principles of the present disclosure. However, the present disclosure is not limited thereto. It will be apparent to those of ordinary skill in the art that various variations and improvements can be made therein without departing from the spirit and essence of the present disclosure, and are also considered to be within the protection scope of the present disclosure.

I/We claim:

1. A shift register, comprising input circuitry, storage circuitry, output circuitry, reset circuitry, pull-down control circuitry, and pull-down circuitry,
wherein the input circuitry is coupled to an input signal terminal, a first voltage terminal, and the storage circuitry, and is configured to receive an input signal and to output the received input signal to the storage circuitry, and a pull-up point is between the input circuitry and the storage circuitry,
the storage circuitry is coupled to the output circuitry and is configured to store the input signal,
the output circuitry is coupled to the storage circuitry, a clock signal terminal, and an output signal terminal, and is configured to output a clock signal from the clock signal terminal to the output signal terminal,
the reset circuitry is coupled to a reset signal terminal, a second voltage terminal, and the pull-up point and is configured to reset the pull-up point according to a reset signal,
the pull-down control circuitry is coupled to a third voltage terminal and the pull-down circuitry and is configured to control the pull-down circuitry, and
the pull-down circuitry is coupled to the output signal terminal, a fourth voltage terminal, and the pull-up point and is configured to pull down levels at the output signal terminal and the pull-up point under control of the pull-down control circuitry.

2. The shift register according to claim 1, wherein a pull-down point is between the pull-down control circuitry and the pull-down circuitry, and wherein the pull-down control circuitry comprises:
a first transistor having a control electrode coupled to the third voltage terminal, a first electrode coupled to the third voltage terminal, and a second electrode coupled to the pull-down point; and
boost circuitry coupled between the control electrode and the second electrode of the first transistor and configured to boost a voltage between the control electrode and the second electrode of the first transistor.

3. The shift register according to claim 2, wherein the boost circuitry comprises a first capacitor coupled between the control electrode and the second electrode of the first transistor.

4. The shift register according to claim 3, wherein the pull-down control circuitry further comprises:
a second transistor having a control electrode and a first electrode each coupled to the third voltage terminal, and a second electrode coupled to the control electrode of the first transistor; and
a third transistor having a control electrode coupled to the pull-up point, a first electrode coupled to the second electrode of the first transistor, and a second electrode coupled to the fourth voltage terminal.

5. The shift register according to claim 1, wherein the input circuitry comprises:
a fourth transistor having a control electrode coupled to the input signal terminal, a first electrode coupled to the first voltage terminal, and a second electrode coupled to the pull-up point.

6. The shift register according to claim 1, wherein the output circuitry comprises:
a fifth transistor having a control electrode coupled to the pull-up point, a first electrode coupled to the clock signal terminal, and a second electrode coupled to the output signal terminal.

7. The shift register according to claim 1, wherein the storage circuitry comprises:
a second capacitor having two terminals coupled to the output circuitry, respectively.

8. The shift register according to claim 1, wherein the reset circuitry comprises:
a sixth transistor having a control electrode coupled to the reset signal terminal, a first electrode coupled to the pull-up point, and a second electrode coupled to the second voltage terminal.

9. The shift register according to claim 1, wherein a pull-down point is between the pull-down control circuitry and the pull-down circuitry, and wherein the pull-down circuitry comprises:
a seventh transistor having a control electrode coupled to the pull-down point, a first electrode coupled to the output signal terminal, and a second electrode coupled to the fourth voltage terminal, and
an eighth transistor having a control electrode coupled to the pull-down point, a first electrode coupled to the pull-up point, and a second electrode coupled to the fourth voltage terminal.

10. A method for driving a shift register unit, the method comprising:
in a first phase, receiving, at input circuitry, a valid input signal from an input signal terminal, outputting, by the input circuitry, a signal from a first voltage terminal to a pull-up point, and storing, by storage circuitry, the signal from the first voltage terminal;
in a second phase, outputting, by the output circuitry, a valid clock signal provided by a clock signal terminal to an output signal terminal under the control of a valid voltage output by the storage circuitry;
in a third phase, receiving, at reset circuitry, a valid reset signal from a reset signal terminal; resetting, by the reset circuitry, a voltage at the pull-up point to a voltage from a second voltage terminal under the control of the reset signal; and outputting, by pull-down control circuitry, a valid signal from the third voltage terminal to a pull-down point, wherein a level at the output signal terminal is pulled down by pull-down circuitry under the control of the valid signal at the pull-down point; and
in a fourth phase, keeping outputting, by the pull-down control circuitry, the valid signal from the third voltage terminal to the pull-down point, and keeping pulling down, by the pull-down circuitry, the level at the output signal terminal under the control of the valid signal at the pull-down point.

11. A gate driving circuit comprising a plurality of cascaded shift registers according to claim 1, wherein an output signal terminal of a shift register at a previous stage is coupled to an input signal terminal of a shift register at a current stage, and an output signal terminal of a shift register at a next stage is coupled to a reset signal terminal of the shift register at the current stage.

12. A display apparatus comprising the gate driving circuit according to claim 11.
